(19) United States
(12) Patent Application Publication
(10) Pub. No.: US 2013/0107779 A1
(43) Pub. Date: May 2, 2013

(54) WIRELESS TERMINAL DEVICE, COMMUNICATION CONTROL METHOD, AND RECORDING MEDIUM

(71) Applicant: Kyocera Corporation, Kyoto (JP)

(72) Inventors: Masaya Kawakita, Kanagawa (JP); Daisuke Mori, Kanagawa (JP)

(73) Assignee: KYOCERA CORPORATION, Kyoto (JP)

(21) Appl. No.: 13/661,996

(22) Filed: Oct. 26, 2012

(30) Foreign Application Priority Data
Oct. 27, 2011 (JP) 2011-235971

(51) Int. Cl. H04W 52/02

(52) U.S. Cl. 370/311

(57) ABSTRACT

A smart phone includes: a communication processing unit that performs wireless communication by WiFi; a touch screen display; and a controller which, when power of the touch screen display is turned OFF in an active state of WiFi, determines whether or not data communication is being performed by WiFi, and when it is determined that the data communication is not being performed by WiFi, makes the smart phone transfer to a power save mode.

This application is based on and claims the benefit of priority from Japanese Patent Application No. 2011-235971, filed on 27 Oct. 2011, the content of which is incorporated herein by reference.

### BACKGROUND OF THE INVENTION

1. Field of the Invention

The present invention relates to a wireless terminal device, a communication control method, and a recording medium that stores a program, which enable transition to a power saving state.

2. Related Art

Wireless terminal devices that include a touch screen display are known heretofore, such as a smart phone and a tablet device.

Techniques for reducing power consumption in wireless terminal devices have been proposed (for example, refer to Japanese Unexamined Patent Application, Publication No. 2009-49875).

### SUMMARY OF THE INVENTION

An object of the present invention is to provide a wireless terminal device, a communication control method, and a recording medium that stores a program, which can reduce power consumption while avoiding deterioration in convenience.

A wireless terminal device according to the present invention comprises: a first communication unit which performs wireless communication by a first wireless communication system defined in IEEE 802.11; a display unit; a controller which, when power of the display unit is turned OFF in an active state of the first wireless communication system, determines whether or not data communication is being performed by the first wireless communication system, and when it is determined that the data communication is not being performed by the first wireless communication system, makes the first communication unit transfer to a power save mode defined in IEEE 802.11.

In addition, it is preferable that the control unit makes the first communication unit maintain the active state when it is determined that the data communication is being performed by the first wireless communication system.

In addition, it is preferable that the control unit determines whether or not data communication is being performed by the first wireless communication system after a predetermined time period after the power of the display unit has been turned OFF.

In addition, it is preferable that the control unit repeats the determination at intervals of a predetermined time period until it is determined that data communication is not being performed by the first wireless communication system while the power of the display unit is turned OFF.

In addition, it is preferable that the wireless terminal device according to the present invention further comprises a second communication unit which performs wireless communication by a second wireless communication system, wherein when the first communication unit transfers to the power save mode while the power of the display unit is turned OFF, the control unit makes the second communication unit establish a data communication session and transfer data communication to the second wireless communication system.

In addition, it is preferable that the second wireless communication system complies with a telecommunications standard for a cellular system.

In addition, it is preferable that the control unit makes the first communication unit search for the first wireless communication system when the power of the display unit is turned ON after making the first communication unit transfer to the power save mode while the power of the display unit is OFF.

A communication control method according to the present invention is a communication control method of a wireless terminal device that includes a communication unit which performs wireless communication by a wireless communication system defined in IEEE 802.11, and a display unit, comprising the steps of: determining whether or not data communication is being performed by the wireless communication system when power of the display unit is turned OFF in an active state of the wireless communication system; and making the communication unit transfer to a power save mode defined in IEEE 802.11 when it is determined that the data communication is not being performed by the wireless communication system.

A non-transitory computer-readable medium according to the present invention stores a program that instructs a wireless terminal device including a communication unit which performs wireless communication by a wireless communication system defined in IEEE 802.11, and a display unit, the program instructing the steps of: determining whether or not data communication is being performed by the wireless communication system when power of the display unit is turned OFF in an active state of the wireless communication system; and making the communication unit transfer to a power save mode defined in IEEE 802.11 when it is determined that the data communication is not being performed by the wireless communication system.

According to the present invention, the wireless terminal device can reduce power consumption while suppressing deterioration in convenience.

### BRIEF DESCRIPTION OF THE DRAWINGS

FIG. 1 is a perspective diagram showing an exterior view of a smart phone according to an embodiment;

FIG. 2 is a front view showing an exterior view of the smart phone according to the embodiment;

FIG. 3 is a back elevation view showing an exterior view of the smart phone according to the embodiment;

FIG. 4 is a block diagram showing an arrangement of the smart phone according to the embodiment;

FIG. 5 is a block diagram showing detailed functions of a communication unit and a controller according to the embodiment;

FIG. 6 is a diagram showing an example of the state transfer according to the embodiment in time series; and

FIG. 7 is a flow chart showing processing according to the embodiment,

### DETAILED DESCRIPTION OF THE INVENTION

An embodiment for carrying out the present invention will be described in detail with reference to the drawings. Hereinafter, a smart phone will be described as an example of a wireless terminal device.

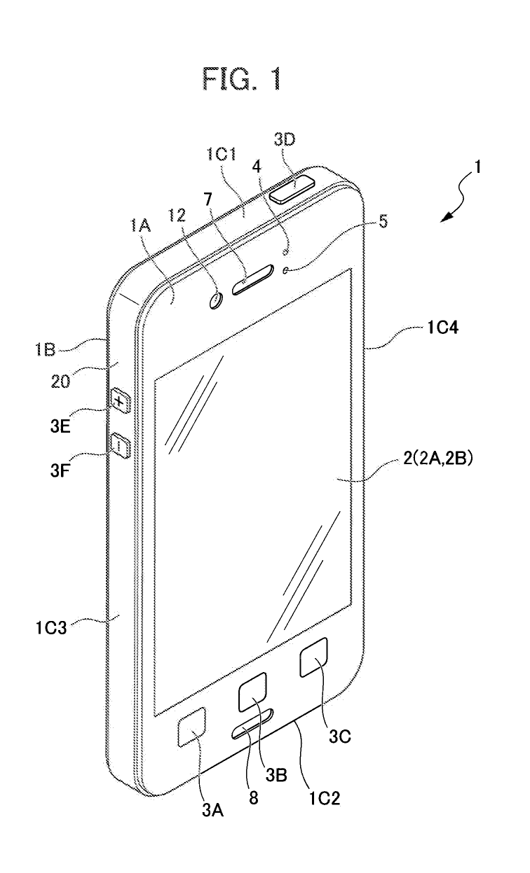

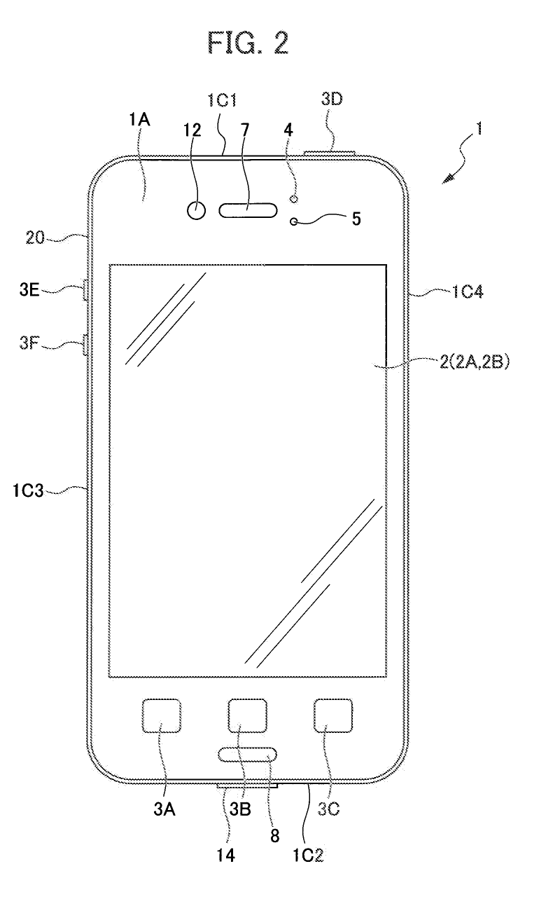

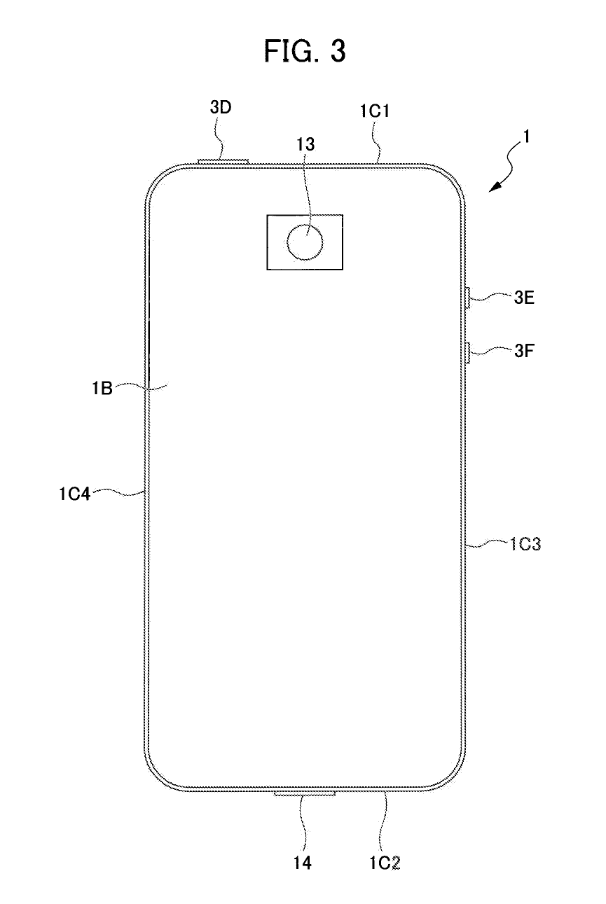

An exterior view of a smart phone 1 according to the embodiment will be described with reference to FIG. 1 to FIG. 3. As shown in FIG. 1 to FIG. 3, the smart phone 1 has a housing 20. The housing 20 has a front face 1A, a back face 1B, and side faces 1C1 to 1C4. The front face 1A is a front face of the housing 20. The back face 1B is a back face of the housing 20. The side faces 1C1 to 1C4 are side faces that connect the front face 1A and the back face 1B. Hereinafter, the side faces 1C1 to 1C4 may be generically referred to as a side face 1C without specifying the surface.

On the front face 1A, the smart phone 1 has a touch screen display 2, buttons 3A-3C, an illuminance sensor 4, a proximity sensor 5, a receiver 7, a microphone 8, and a camera 12. The smart phone 1 has a camera 13 on the back face 1B. The smart phone 1 has buttons 3D-3F, and an external interface 14 on the side face 10. Hereinafter, the buttons 3A-3F may be generically referred to as a button 3 without specifying the button.

The touch screen display 2 has a display 2A and a touch screen 2B. The display 2A includes a display device such as a liquid crystal display, an organic EL (Electro-Luminescence) panel, or an inorganic EL panel. The display 2A displays characters, images, symbols, graphics, or the like,

The touch screen 2B detects contact of fingers, stylus pens, or the like, on the touch screen display 2. The touch screen 2B can detect a position where a plurality of fingers, the stylus pen, or the like make contact with the touch screen display 2.

The detection method of the touch screen 2B may be of any method, such as a capacitive sensing method, a resistance film method, a surface acoustic wave method (or ultrasonic sensing method), an infrared method, an electromagnetic induction method, or a load detection method. Hereinafter, for simplicity of descriptions, a finger, a stylus pen or the like, by which contact with the touch screen display 2 is detected by the touch screen 2B, may be simply referred to as “a finger”.

The smart phone 1 distinguishes kinds of gestures based on the contact, the contact position, the contact time, or contact count number detected by the touch screen 2B. A gesture is an operation performed with respect to the touch screen display 2 Gestures distinguished by the smart phone include touch, long touch, release, swipe, tap, double tap, long tap, dragging, flicking, pinch-in, pinch-out, etc.

A touch is a gesture of a finger making contact with the touch screen display 2 (for example, its surface). The smart phone 1 distinguishes as a touch the gesture of a finger making contact with the touch screen display 2. A long touch is a gesture of a finger making contact with the touch screen display 2 for a predetermined time period or longer. The smart phone 1 distinguishes the gesture of a finger making contact with the touch screen display 2 for a predetermined time period or longer as a long touch.

A release is a gesture of a finger moving away from the touch screen display 2. The smart phone 1 distinguishes as a release the gesture of a finger moving away from the touch screen display 2. A swipe is a gesture of a finger moving while still in contact with the touch screen display 2. The smart phone 1 distinguishes as a swipe the gesture of a finger moving while still in contact with the touch screen display 2.

A tap is a gesture of a release following a touch. The smart phone 1 distinguishes as a tap the gesture of a release following a touch. A double tap is a gesture where the gesture of a release following a touch is repeated twice in succession. The smart phone 1 distinguishes a gesture where the gesture of a release following a touch is repeated twice in succession as a double tap.

A long tap is a gesture of a release following a long touch. The smart phone 1 distinguishes the gesture of a release following a long touch as a long tap. Dragging is a gesture performing a swipe from a starting point of a region where a movable object is displayed. The smart phone 1 distinguishes as dragging the gesture performing a swipe from a starting point of a region where a movable object is displayed.

Flicking is a gesture performing a release while moving the finger to one direction at high speed following a touch. The smart phone 1 distinguishes as flicking the gesture performing a release while moving the finger to one direction at high speed following a touch. Flicking includes an upper flick where the finger moves upwards on the screen, a lower flick where the finger moves downwards on the screen, a right flick where the finger moves rightwards on the screen, and a left flick where the finger moves leftwards on the screen.

A pinch-in is a gesture of a plurality of fingers performing swipes in directions where the fingers approach each other. The smart phone 1 distinguishes the gesture of a plurality of fingers performing swipes in directions where the fingers approach each other as a pinch-in. A pinch-out is a gesture of a plurality of fingers performing swipes in directions where the fingers move farther apart from each other. The smart phone 1 distinguishes the gesture of a plurality of fingers performing swipes in directions where the fingers move farther apart from each other as a pinch-out.

The smart phone 1 performs operations according to these gestures distinguished through the touch screen 2B. Therefore, it is possible to achieve an operability that is intuitive and easy-to-use for the user. The operations that the smart phone 1 performs according to the gestures thus distinguished differ according to the screen displayed on the touch screen display 2.

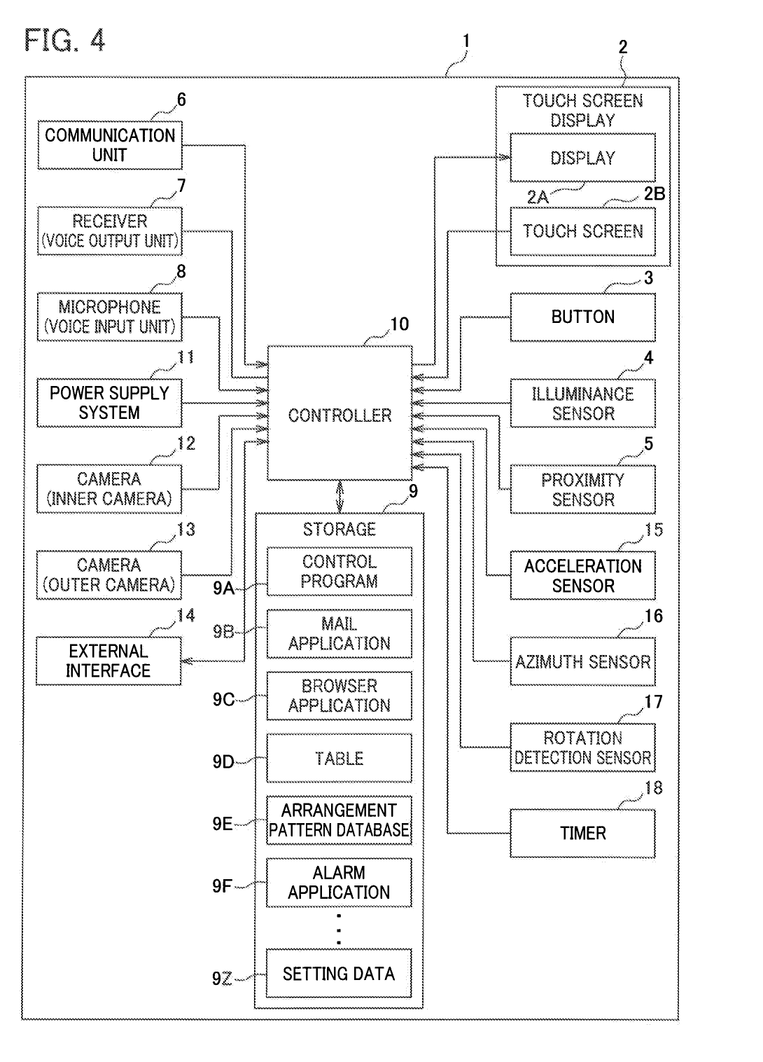

FIG. 4 is a block diagram showing an arrangement of the smart phone 1. The smart phone 1 includes the touch screen display 2, the button 3, the illuminance sensor 4, the proximity sensor 5, a communication unit 6, the receiver the microphone 8, a storage 9, a controller 10, the cameras 12 and 13, the external interface 14, an acceleration sensor 15, an azimuth sensor 16, and a rotation detection sensor 17.

The touch screen display 2 has a display 2A and a touch screen 2B, as described above. The display 2A displays characters, images, symbols, graphics, or the like. The touch screen 2B detects gestures.

The button 3 is operated by the user. The button 3 has buttons 3A-3F. The controller 10 detects an operation on the buttons by working together with the button 3. Operations on the buttons include a click, a double click, a push, and multiple pushes, for example.

For example, the buttons 3A-3C may be a home button, a back button, or a menu button. For example, the button 3D may be a power on/off button of the smart phone 1. The button 3D may also serve as a sleep/sleep-release button. For example, the buttons 3E and 3F may be sound volume buttons.

The illuminance sensor 4 detects illuminance. For example, illuminance may be light Intensity, level, brightness, etc. The illuminance sensor 4 is used for adjusting brightness of the display 2A, for example.

The proximity sensor 5 detects the existence of neighboring objects in a non-contact way. The proximity sensor 5 detects when the touch screen display 2 is brought close to a human face, for example.

The communication unit 6 communicates via wireless. The communication methods performed by the communication unit 6 comply with wireless communication standards. For example, the wireless communication standard includes telecommunications standards for cellular phones, such as 2G, 3G, and 4G. For example, the telecommunications standard for cellular phones includes LTE (Long Term Evolution), W-CDMA, CDMA2000, PDC, GSM, PHS (Personal Handy-phone System), etc. For example, the wireless communication standard includes WiMAX (Worldwide Interoperability for Microwave Access), IEEE 802.11, Bluetooth, IrDA, NFC (Near Field Communication), etc. The communication unit 6 may support one or more of the telecommunications standards described above.

The receiver 7 outputs voice signals transmitted from the controller 10 as a voice. The microphone 8 converts the voice of the user into voice signals for transmitting to the controller 10. It should be noted that the smart phone 1 may have a speaker in addition to the receiver 7. The smart phone 1 may have a speaker instead of the receiver

The storage 9 stores programs and data. In addition, the storage 9 is used also as a workspace for temporarily storing the processing result of the controller 10. The storage 9 may include any storage device, such as a semiconductor storage device or a magnetic storage device. In addition, the storage 9 may include a plurality of kinds of storage devices. In addition, the storage 9 may include a combination of transportable storage media, such as memory cards, and a reading device for storage media.

The program stored in the storage 9 includes applications performed in the foreground or the background and control programs that support operations of the applications. For example, the application displays a predetermined screen on the display 2A and makes the controller 10 perform processing according to the gesture detected by the touch screen 2B. The control program is an OS, for example. The applications and control programs may be installed in the storage 9 via wireless communication by the communication unit 6, or via storage media.

The storage 9 stores a control program 9A, a mail application 9B, a browser application 9C, and setting data 9Z, for example. The mail application 9B provides electronic mail functions, such as creation, transmission, reception, display, or the like, of electronic mails. The browser application 9C provides a WEB browsing function for displaying WEB pages. In Table 9D, various tables, such as a key assigning table, are stored. The arrangement pattern database 9E stores arrangement patterns of icons or the like displayed on the display 2A. The setting data 9Z provides various kinds of setting functions related to operations of the smart phone 1.

The control program 9A provides functions relating to various controls for operating the smart phone 1. The control program 9A realizes a voice conversation, for example by controlling the communication unit 6, the receiver 7, the microphone 8, or the like. The function provided by the control program 9A includes functions to perform various controls, such as changing the information displayed on the display 2A according to the gesture detected through the touch screen 2B. It should be noted that the function provided by the control program 9A may be used in combination with functions provided by other programs, such as the mail application 9B.

The controller 10 is a CPU (Central Processing Unit), for example. The controller 10 may be an integrated circuit, such as an SoC (System-on-a-chip) where other components such as the communication unit 6 are integrated therein. The controller 10 realizes various kinds of functions by controlling overall operations of the smart phone 1.

Specifically, the controller 10 realizes the various functions by controlling the display 2A and communication unit 6 or the like by executing instructions included in the program stored in the storage 9 while referring to the data stored in the storage 9 as necessary. The controller 10 may change control according to the detection result of various detection units, such as the touch screen 2B, the button 3, and the acceleration sensor 15.

The controller 10 performs various controls, such as changing information displayed on the display 2A according to the gesture detected through the touch screen 2B, for example, by executing the control program 9A.

The camera 12 is an inner camera which takes a photograph of an object facing the front face 1A. The camera 13 is an outer camera which takes a photograph of an object facing the back face 1B.

The external interface 14 is a terminal to which other devices connect. The external interface 14 may be a general-purpose terminal, such as connectors for USB (Universal Serial Bus), HDMI (High-Definition Multimedia Interface), Light Peak (Thunderbolt), and an earphone microphone. The external interface 14 may be a terminal designed for dedicated use such as a Dock connector. The device connected to the external interface 14 includes external storage, a speaker, and a communication device, for example.

The acceleration sensor 15 detects direction and size of acceleration of the smart phone 1. The azimuth sensor 16 detects the direction of earth magnetism. The rotation detection sensor 17 detects rotation of the smart phone 1. The detection result of the acceleration sensor 15, the azimuth sensor 16, and the rotation detection sensor 17 is used in combination in order to detect changes in the position and posture of the smart phone 1.

The smart phone 1 thus constituted can reduce power consumption. Hereinafter, the specific arrangement will be described.

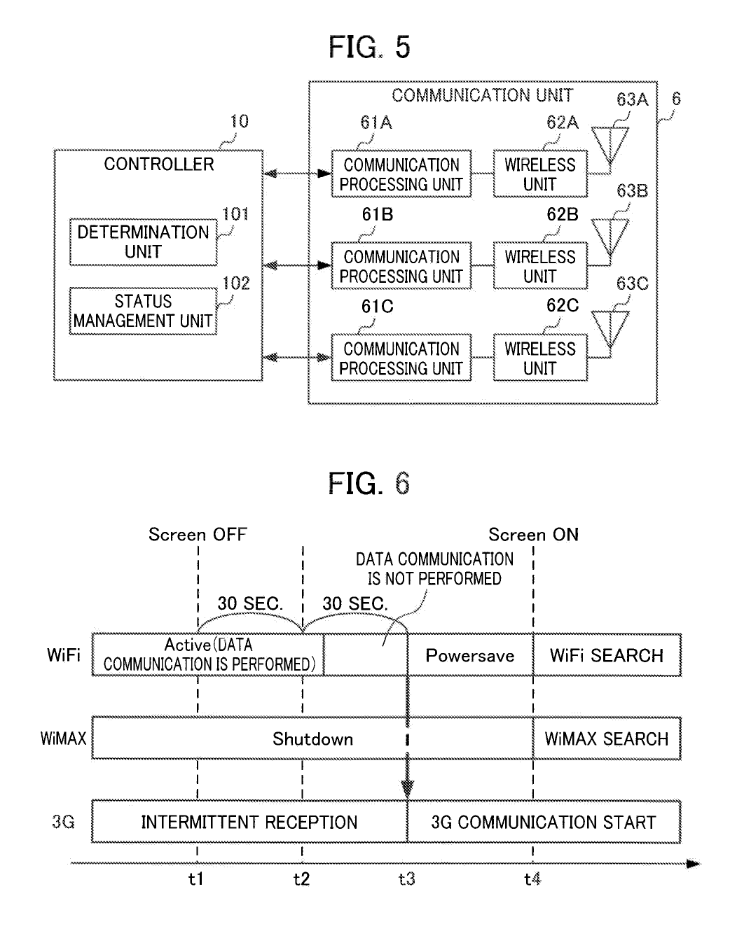

FIG. 5 is a block diagram showing detailed functions of the communication unit 6 and the controller 10 (control unit) in the smart phone 1.

It should be noted that the smart phone 1 supports wireless communication systems of WiFi defined in IEEE 802.11, WiMAX, and 3G standards (for example, CDMA2000 1xEVDO, W-CDMA, etc. Hereafter referred to as a “3G system”) as a wireless communication system performing data communication.

The communication unit 6 includes: a communication processing unit 61A (communication unit), a wireless unit 62A, and an antenna 63A that support WiFi; a communication processing unit 61B, a wireless unit 62B and an antenna 63B that support WiMAX; and a communication processing unit 61C, a wireless unit 62C and an antenna 63C that support the 3G system.

The communication processing units 61 (A, B, and C) control respective wireless units 62 (A, B, and C) and manage the state transfers, such as connection and disconnection to and from the wireless communication system.

The wireless units 62 (A, B, and C) perform demodulation processing to the signal received from respective antennas 63 (A, B, and C) and supply the signal thus processed to the respective communication processing units 61 (A, B, and C), and further perform modulation processing to the signal supplied from the communication processing units 61, and transmit the signal thus processed from the antennas 63 to external devices.

The controller 10 includes a determination unit 101 and a status management unit 102, and performs predetermined control with respect to the communication processing units 61 (A, B, and C).

The determination unit 101 determines whether or not data communication is being performed by WiFi when the communication processing unit 61A is in a state available for data communication by WiFi, that is, when it is in an active state defined in IEEE 802.11, and when the power of the touch screen display 2 (display unit) is turned OFF.

Specifically, the determination unit 101 determines whether or not data communication is being performed by WiFi after a predetermined time period (for example, 30 seconds) after the power of the touch screen display 2 is turned OFF. Furthermore, while the power of the touch screen display 2 is OFF, the determination unit 101 repeats the determination at intervals of a predetermined time period (for example, every 30 seconds) until it is determined that data communication is not being performed by WiFi.

At this time, the determination unit 101 determines in a layer above the physical layer whether or not data communication is being performed according to the presence or absence of packets of transmission and reception data.

The status management unit 102 selects any one of a plurality of communication processing units 61 in an order of predetermined priority, and transfers it to an active state where data communication is enabled. In the present embodiment, priority is given in the order of WiFi (high rank bearer), WiMAX (middle rank bearer), and the 3G system (low rank bearer), to be connected by the status management unit 102. That is, normally the status management unit 102 connects to WiMAX when it is not possible to connect to WiFi, and connects to the 3G system when it is not possible to connect to WiMAX.

In addition, when the determination unit 101 determines that data communication is being performed, the status management unit 102 makes the communication processing unit 61A maintain the active state of WiFi, and when it is determined that data communication is not being performed, the status management unit 102 makes the communication processing unit 61A transfer to a power saving state, in particular, to a power save mode defined in IEEE 802.11.

Furthermore, when the power of the touch screen display 2 is turned OFF and data communication is not being performed in any of the plurality of communication processing units 61, the status management unit 102 makes a default communication processing unit 61, which is communication processing unit 61C in the present embodiment, establish a corresponding data communication connection (PPP session) by the 3G system. Here, the 3G system supported by the communication processing unit 610 is a wireless communication system complying with a telecommunications standard of a cellular system and is always in operation for intermittent reception, and therefore, it is possible to reduce power consumption in establishing sessions for data communication compared with the case of connecting to other communications systems.

In addition, when data communication has not being performed for a predetermined time period (for example, 3 seconds) after making the communication processing unit 61C establish data communication, the status management unit 102 makes the communication processing unit 61C transition to a dormant state and power consumption is reduced.

FIG. 6 is a diagram showing an example of the state transfer of the communication processing units 61 (A, B, and C) in time series.

Before time t1, the communication processing unit 61A is performing data communication in an active state. In addition, the communication processing unit 61B is in a shutdown mode where it is disconnected from WiMAX and where a search for WiMAX is not performed. Furthermore, the communication processing unit 61C connects to the 3G system and is in an intermittent receiving state for communication-arrival.

At time t1, when the power of the touch screen display 2 is turned OFF, a timer used by the determination unit 101 starts. At this time, there is no state transfer with regard to any of the communication processing units 61 (A, B, and C) and states prior to time t1 continue,

When the timer finishes at time t2 after 30 seconds has elapsed since time t1, the determination unit 101 determines whether or not data communication is being performed by WiFi. If data communication is continuing at this time, there is no state transfer and a timer that measures 30 seconds is started again.

After the data communication ends between time t2 and time t3, the determination unit 101 determines that data communication is not being performed at time t3 when the timer finishes. Then, the status management unit 102 makes the communication processing unit 61A transition to the power save mode and disconnects connection to WiFi.

If WiFi, which is a high rank bearer, is disconnected, connection to WiMAX, which is a middle rank bearer, is usually tried, but since the power of the touch screen display 2 is OFF, the status management unit 102 starts data communication by the 3G system, which is a lowest rank bearer. However, since there is no transmission and reception data, the communication processing unit 61C transfers to a dormant state and prepares for generation of the transmission and reception data,

When the power of the touch screen display 2 is turned ON at time t4, searching for WiFi and WiMAX, to which priority is given over the 3G system, is started, and if it is successful in capturing a system, handling of data communication is taken over by the high rank bearer or the middle rank bearer from the low rank bearer.

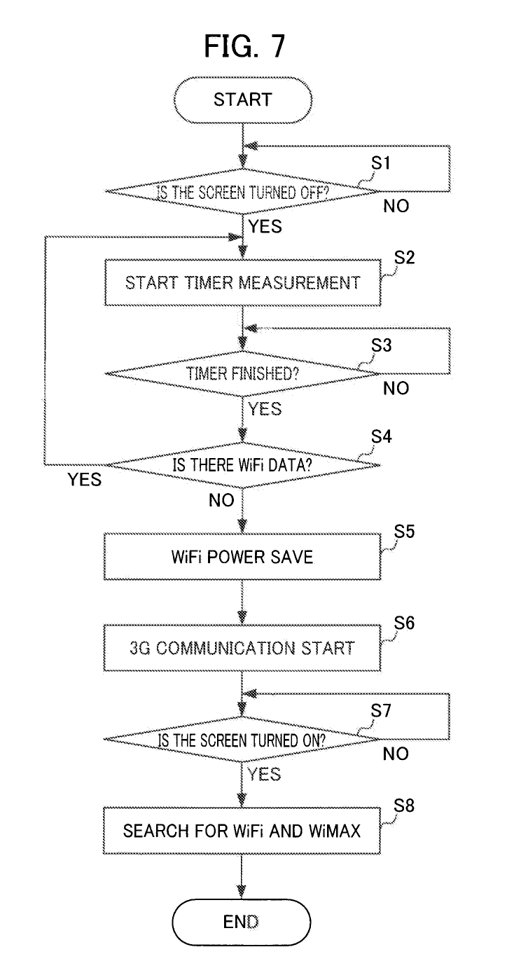

FIG. 7 is a flow chart showing processing according to the state transfer of the communication processing unit 61 in the smart phone 1.

In Step S1, the controller 10 determines whether or not the power of the touch screen display 2 has been turned OFF. If this determination is YES, the process moves to Step S2, and if the determination is NO, Step S1 is continued.

In Step S2, in response to the determination in Step S1 that the power of the touch screen display 2 has been turned OFF in Step S1, the determination unit 101 starts measuring the time of the predetermined time period (30 seconds) by the timer.

In Step S3, the determination unit 101 determines whether or not the timer started in Step S2 has finished. If this determination is YES, the process moves to Step S4, and if the determination is NO, Step S3 is continued.

In Step S4, the determination unit 101 determines whether or not data communication is being performed by WiFi. If this determination is YES, the process returns to Step S2 and starts measuring the time by the timer again. Meanwhile, if the determination is NO, the process moves to Step S5.

In Step S5, since data communication is not being performed and the power of the touch screen display 2 is OFF, the status management unit 102 determines that there is a low likelihood of newly generated data communication and transfers the communication processing unit 61A that supports WiFi to the power save mode

In Step S6, in preparation for data communication being requested later upon the power of the touch screen display 2 being turned ON, the status management unit 102 establishes the session for data communication by the communication processing unit 61C that supports the 3G system and is already started and is standby for incoming communication.

In Step S7, the controller 10 determines whether or not the power of the touch screen display 2 has been turned ON. If this determination is YES, the process moves to Step S8, and if the determination is NO, Step S7 is continued.

In Step S8, the status management unit 102 makes the communication processing unit 61A and the communication processing unit 61B that support WiFi and WiMAX, whose priorities are higher than the 3G system, start the search for respective wireless communication systems.

As described above, according to the present embodiment, since the smart phone 1 transfers into a power save mode if data communication is not being performed by WiFi when the power of the touch screen display 2 is turned OFF, it is possible to reduce electric power unnecessarily by the active state being needlessly continued. In addition, since the smart phone 1 maintains an active state if data communication is being performed when the power of the touch screen display 2 is turned OFF, it is possible to suppress deterioration in convenience without data communication being disconnected.

In addition, since the smart phone 1 determines the existence of data communication after a predetermined time period, after the power of the touch screen display 2 has been turned OFF, it is possible, for example, to prevent disconnection of WiFi unnecessarily and to suppress consumption of electric power for searching for WiFi again, when ON and OFF power operations continue for a short time period (for example, less than 30 seconds).

Furthermore, while the power of the touch screen display 2 is OFF, the smart phone 1 determines the existence of data communication at intervals of a predetermined time period (for example, every 30 seconds) until it is determined that data communication is not being performed. Therefore, since the smart phone 1 supervises termination of data communication and transfers to the power save mode at appropriate timing, it is possible to reduce power consumption while suppressing deterioration in convenience.

In addition, when the power of the touch screen display 2 is turned OFF and the communication processing unit 61A for Win, which is the high rank bearer, transfers into a power save mode, the smart phone 1 establishes a data communication session in the communication processing unit 61C of the 3G system, which is a low rank bearer, while maintaining the communication processing unit 61B of WiMAX, which is a middle rank bearer, in a shutdown state. Therefore, since the smart phone 1 connects data communication by the 3G system, which is a wireless communication system consuming minimal power for connecting data communication, while the power of the touch screen display 2 is turned OFF, without searching and without returning to an active state for WiMAX, it is possible to reduce power consumption.

At this time, since the 3G system, which is a cellular system, is already activated so as to be standby for incoming communication, it is possible to suppress increases in power consumption when connecting for data communication. In addition, it is possible to perform data communication immediately when the power of the touch screen display 2 is turned ON again.

Furthermore, since the 3G system that has established connection for data communication, transfers to a dormant state, the smart phone 1 can suppress power consumption further.

An embodiment of the present invention has been described above, but the present invention is not limited to the embodiment described above In addition, the effects described above in the embodiment of the present invention are merely results describing the most preferable effects that arise from the present invention, and the effects that arise from the present invention is not limited to the effects described in the above embodiment.

The arrangement of the smart phone 1 shown in FIG. 4 and FIG. 5 is merely an example and may be modified as appropriate within a scope that does not depart from the spirit of the present invention.

For example, although the display unit is a touch screen display 2 that has a detection function in the touch screen 2B, it may be a display device that does not have a detection function.

In addition, although the communication processing units 61 are described as units that support WiFi, W MAX, and the 3G system, it is not limited to this. The communication processing units 61 may support other wireless communication systems and may support four or more wireless communication systems.

In addition, a part or all of the program that the storage 9 stores in FIG. 4 may be downloaded from other devices via wireless communication by the communication unit 6. In addition, a part or all of the program that the storage 9 stores in FIG. 4 may be stored in storage media, which are readable from a reader device included in the storage 9. In addition, a part or all of the program that the storage 9 stores in FIG. 4 may be stored in storage media, such as CD, DVD, or Blu-ray disc, which are readable from a reader device connected to the external interface 14,

In addition, each program shown in FIG. 4 may be divided into a plurality of modules, and may be combined with other programs,

In addition, in the above embodiment, although a smart phone is described as an example of the wireless terminal device, the wireless terminal device is not limited to smart phones. For example, the wireless terminal device may be a portable electronic device, such as a mobile phone, a portable personal computer, a digital camera, a media player, a digital book reader, a navigator, or a game machine, or a module dedicated for communication which specializes in a communication function. In addition, the wireless terminal devices may be a non-portable electronic device, such as a desktop PC or a television set.

What is claimed is:

1. A wireless terminal device comprising:
a first communication unit which performs wireless communication by a first wireless communication system defined in IEEE 802.11;
a display unit;
a controller which, when power of the display unit is turned OFF in an active state of the first wireless communication system, determines whether or not data communication is being performed by the first wireless communication system, and
when it is determined that the data communication is not being performed by the first wireless communication system, makes the first communication unit transfer to a power save mode defined in IEEE 802.11.

2. The wireless terminal device according to claim 1, wherein the control unit makes the first communication unit maintain the active state when it is determined that data communication is being performed by the first wireless communication system.

3. The wireless terminal device according to claim 1, wherein the control unit determines whether or not data communication is being performed by the first wireless communication system after a predetermined time period after the power of the display unit has been turned OFF.

4. The wireless terminal device according to claim 3, wherein the control unit repeats the determination at intervals of a predetermined time period until it is determined that data communication is not being performed by the first wireless communication system while the power of the display unit is turned OFF.

5. The wireless terminal device according to claim 1, further comprising
a second communication unit which performs wireless communication by a second wireless communication system, wherein
when the first communication unit transfers to the power save mode while the power of the display unit is turned OFF, the control unit makes the second communication unit establish a data communication session and transfer data communication to the second wireless communication system.

6. The wireless terminal device according to claim 5, wherein the second wireless communication system complies with a telecommunications standard for a cellular system.

7. The wireless terminal device according to claim 1, wherein the control unit makes the first communication unit search for the first wireless communication system when the power of the display unit is turned ON, after making the first communication unit transfer to the power save mode while the power of the display unit is OFF.

8. A communication control method of a wireless terminal device that includes a communication unit which performs wireless communication by a wireless communication system defined in IEEE 802.11, and a display unit, the method comprising the steps of:
determining whether or not data communication is being performed by the wireless communication system when power of the display unit is turned OFF in an active state of the wireless communication system; and
making the communication unit transfer to a power save mode defined in IEEE 802.11 when it is determined that the data communication is not being performed by the wireless communication system.

9. A non-transitory computer-readable medium that stores a program that instructs a wireless terminal device including a communication unit which performs wireless communication by a wireless communication system defined in IEEE 802.11, and a display unit, to perform the steps of:
determining whether or not data communication is being performed by the wireless communication system when power of the display unit is turned OFF in an active state of the wireless communication system; and
Making the communication unit transfer to a power save mode defined in IEEE 802.11 when it is determined that the data communication is not being performed by the wireless communication system.
